(19) United States
(12) Patent Application Publication
(10) Pub. No.: US 2003/0203231 A1
(43) Pub. Date: Oct. 30, 2003

(54) UV stabilization of synthetic paper

(75) Inventors: Steven R. Stopper, Duluth, GA (US); Charles Edward Edmundson, Roswell, GA (US)

Correspondence Address: KIMBERLY-CLARK WORLDWIDE, INC., 401 NORTH LAKE STREET, NEENAH, WI, 54956

(73) Assignee: Kimberly-Clark Worldwide, Inc.

(21) Appl. No.: 10/135,976

(22) Filed: Apr. 30, 2002

(51) Int. Cl. B32B 23/08

(52) U.S. Cl. 428/515; 428/511

(57) ABSTRACT

There is provided a synthetic paper for use in outside applications. The paper has good UV stability and may be constructed one, two or more layers. A three layer embodiment has; a core or inner layer and two skin or outer layers. The layers are made with a polyolefin, a filler, a titanium dioxide, a hindered amine and other additives.

### BACKGROUND OF THE INVENTION

Synthetic paper is used in many applications where traditional cotton or pulp based paper will not long survive. Outdoor applications where the paper will be exposed to the elements; heat and particularly rain and most particularly ultraviolet (UV) radiation will result in a significantly reduced life.

Synthetic papers for outdoor use are generally made from polyolefins because they are relatively low cost materials. Polyolefins, unfortunately, are quite susceptible to degradation by UV radiation. Various stabilizers alone have been used in attempts to increase the UV resistance of synthetic papers, but none has proved completely satisfactory.

It is therefore an object of this invention to provide a synthetic paper, which will exhibit UV stability performance superior to previous competitive materials in outdoor use.

### SUMMARY

In response to the discussed difficulties and problems encountered in the prior art, a new synthetic paper has been developed. In one embodiment, the synthetic paper for outdoor applications has three layers; a first outer film layer of a polyolefin, a filler, a titanium dioxide, and a hindered amine, an inner layer of a polyolefin, a filler, a titanium dioxide, and a hindered amine, and a second outer film layer of a polyolefin, a filler, a titanium dioxide, and a hindered amine. The filler may be coated with an acid and the titanium dioxide may be coated with a silica. The paper may also have a phosphite and a hindered phenol in an amount between about 0.1 and 1 weight percent collectively.

The outer layer and/or inner layer polyolefin may be a polypropylene, which may be made by the metallocene process and may include heterophasic polymers. The layers may have a pigment present in an amount less than 5 weight percent. It has been found by the inventors that this paper maintains 75 percent of its tensile and stretch properties after exposure to 1000 hours of accelerated weatherability testing (as described hereinbelow).

More specifically, the three layer embodiment may have a core layer contributing about 90 weight percent the paper and, on either side of the core layer, a skin layer, each skin layer contributing about 5 weight percent of the paper, where the core layer is made from about 65 to about 85 weight percent polypropylene, about 20 to 30 weight percent calcium carbonate, about 2 to 7 weight percent TiO₂, about 0.25 to 1 weight percent hindered amine, and about 0.1 to 0.5 weight percent of a phosphite and a hindered phenol, collectively. The skin layer is made from about 40 to 70 weight percent of polypropylene, about 20 to 30 weight percent calcium carbonate, about 2 to 7 weight percent TiO₂, about 0.25 to 1 weight percent hindered amine, and about 0.1 to 0.5 weight percent of a phosphite and a hindered phenol, collectively.

The skin layer of this embodiment may include a heterophasic polypropylene in an amount between about 5 and 20 weight percent and the polypropylene may be a metallocene polypropylene.

In still another embodiment, the paper of this invention may have only one layer made from between about 45 and 80 weight percent of a polyolefin, calcium carbonate in an amount of about between about 15 and 50 weight percent, titanium dioxide in an amount between about 0.25 and 10 weight percent and a hindered amine light stabilizing material present at an amount of about between about 0.25 and 10 weight percent. The polypropylene may be produced by a metallocene process and the paper may include a heterophasic polypropylene.

The single layer embodiment may also have about 0.1 to 1 weight percent of a phosphite and a hindered phenol, collectively The single layer synthetic paper may more particularly have polypropylene present in an amount between about 55 and 70 weight percent, calcium carbonate is present in an amount between about 20 and 40 weight percent, titanium dioxide is present in an amount between about 2 and 7 weight percent and hindered amine is present in an amount between about 0.25 and 5 weight percent.

### DETAILED DESCRIPTION OF THE INVENTION

A synthetic paper has been developed by the inventors which has sufficient physical properties to function in an outdoor environment. These properties include good water repellency, stiffness, durability to prolonged exposure to sunlight, and good chemical resistance.

The thermoplastic polymers which may be used in the practice of this invention may be any known to those skilled in the art to be commonly used in synthetic paper making.

Such polymers include polyolefins, polyesters and polyamides, and mixtures thereof, more particularly polyolefins such as polyethylene, polypropylene, polybutene, ethylene copolymers, propylene copolymers and butene copolymers and mixtures thereof.

The synthetic paper of this invention is desirably a three-layer film laminate of the ABA type. The paper has two outer or “skin” layers; the “A” layers, and one inner or “core” layer; the “B” layer.

The ABA layers of the paper of this invention are desirably polyolefin, particularly polypropylene having a melt flow rate (MFR) of between about 3 and 50, more particularly between about 7 and 15. The MFR is an indication of the viscosity of the polymer with a higher number indicating a lower viscosity. The MFR is expressed as the weight of material which flows from a capillary of known dimensions under a specified load or shear rate for a measured period of time and is measured in grams/10 minutes at 230° C. according to, for example, ASTM test D 1238-82, condition L.

The polyolefin should be present in the B layer in an amount of about between about 50 and 90 weight percent, desirably between about 60 and 85 weight percent, more desirably between about 65 and 85 weight percent. The polyolefin should be present in the A layer in an amount of about between about 35 and 85 weight percent, desirably between about 40 and 70.

A suitable polymer for the polyolefin of the ABA layers is a ethylene or propylene homopolymer or co-polymer. Such polymers are available from a number of manufacturers including Shell Oil Company and Exxon/Mobil Corporation. A particularly well-suited polymer is available from Exxon/Mobil under the designation PLTD 1542 metallocene polypropylene (mPP) homopolymer, and has a melt flow rate of about 14. Another suitable polymer is PLTD 1592 mPP, also from Exxon/Mobil, and having a melt flow rate of 11.5. Yet another well-suited polymer from Exxon/Mobil is available under the designation ACHIEVE® 1654 mPP homopolymer and has a melt flow rate of about 16.

Polymers produced using metallocene catalysts have the unique advantage of having a very narrow molecular weight range. Controlling the isotacticity of a polymer can also result in the production of a polymer, which contains blocks of isotactic and blocks of atactic material alternating over the length of the polymer chain. This construction results in an elastic polymer by virtue of the atactic portion. Such polymer synthesis is discussed in the journal Science, vol. 267, (Jan. 13, 1995) at p. 191 in an article by K. B. Wagner. Wagner, in discussing the work of Coates and Waymouth, explains that the catalyst oscillates between about the stereochemical forms resulting in a polymer chain having running lengths of isotactic sterocenters connected to running lengths of atactic centers. Isotactic dominance is reduced producing elasticity. Geoffrey W. Coates and Robert M. Waymouth, in an article entitled “Oscillating Stereocontrol: A Strategy for the Synthesis of Thermoplastic Elastomeric Polypropylene” at page 217 in the same issue, discuss their work in which they used metallocene bis(2-phenylindenyl)-zirconium dichloride in the presence of methylaluminoxane (MAO), and, by varying the pressure and temperature in the reactor, oscillate the polymer form between about isotactic and atactic.

Metallocene polymers are available from Exxon/Mobil of Baytown, Tex. under the trade name ACHIEVE® for polypropylene based polymers and EXACT® and EXCEED® for polyethylene based polymers. Dow Chemical Company of Midland, Mich. has polymers commercially available under the name ENGAGE®. These materials are believed to be produced using non-stereo selective metallocene catalysts. Exxon generally refers to their metallocene catalyst technology as “single site” catalysts while Dow refers to theirs as “constrained geometry” catalysts under the name INSIGHT® to distinguish them from traditional Ziegler-Natta catalysts, which have multiple reaction sites.

Regarding metallocene based elastomeric polymers, U.S. Pat. No. 5,204,429 to Kaminsky et al. describes a process which may produce elastic copolymers from cycloolefins and linear olefins using a catalyst which is a sterorigid chiral metallocene transition metal compound and an aluminoxane. The polymerization is carried out in an inert solvent such as an aliphatic or cycloaliphatic hydrocarbon such as toluene. The reaction may also occur in the gas phase using the monomers to be polymerized as the solvent. U.S. Pat. Nos. 5,278,272 and 5,272,236, both to Lai et al., assigned to Dow Chemical and entitled “Elastic Substantially Linear Olefin Polymers” describe polymers having particular elastic properties.

Any layer, though desirably the skin layer, may also contain polymers which are semi-crystalline/amorphous or heterophasic in character in an amount between about 5 and 20 weight percent, particularly between about 5 and 15 weight percent and most particularly about 10 weight percent. Suitable polymers are disclosed in European Patent EP 0444671 B1, European Patent EP 0472946 B2, European Patent EP 0400333 B1, U.S. Pat. No. 5,302,454 and U.S. Pat. No. 5,368,927.

European Patent EP 0444671 B1 teaches a composition comprising first, 10-60 weight percent of a homopolymer polypropylene having an isotactic index greater than 90 or a crystalline copolymer of propylene with ethylene and/or other alpha-olefins containing more than 85 weight percent of propylene and having an isotactic index greater than 85; second, 10-40 weight percent of a copolymer containing prevailingly ethylene, which is insoluble in xylene at room temperature; and third, 30-60 weight percent of an amorphous ethylene-propylene copolymer, which is soluble in xylene at room temperature and contains 40-70 weight percent of ethylene, wherein the propylene polymer composition has a ratio between about the intrinsic viscosities, in tetrahydronaphthalene at 135° C., of the portion soluble in xylene and of the portion insoluble in xylene at room temperature of from 0.8 to 1.2.

European Patent EP 0472946 B2 teaches a composition comprising first, 10-50 weight percent of a homopolymer polypropylene having an isotactic index greater than 80 or a crystalline copolymer of propylene with ethylene, a CH₂═CHR alpha-olefin where R is a 2-8 carbon alkyl radical or combinations thereof, which copolymer contains more than 85 weight percent of propylene; second, 5-20 weight percent of a copolymer containing ethylene, which is insoluble in xylene at room temperature; and third, 40-80 weight percent of a copolymer fraction of ethylene and propylene or another CH₂═CHR alpha-olefin, where R is a 2-8 carbon alkyl radical, or combinations thereof, and, optionally, minor portions of a diene, the fraction containing less than 40 weight percent of ethylene and being soluble in xylene at ambient temperature and having an intrinsic viscosity from 1.5 to 4 dl/g; where the percent by weight of the sum of the second and third fractions with respect to the total polyolefin composition is from 50 to 90 percent and the second to third fraction weight ratio being lower than 0.4.

European Patent EP 0400333 B1 teaches a composition comprising first, 10-60 weight percent of a homopolymer polypropylene having an isotactic index greater than 90 or a crystalline propylene copolymer with ethylene and/or a CH₂═CHR olefin where R is a 2-8 carbon alkyl radical containing more than 85 weight percent of propylene and having an isotactic index greater than 85; second, 10-40 weight percent of a crystalline polymer fraction containing ethylene, which is insoluble in xylene at room temperature; and third, 30-60 weight percent of an amorphous ethylene-propylene copolymer containing optionally small proportions of a diene, which is soluble in xylene at room temperature and contains 40-70 weight percent of ethylene.

U.S. Pat. No. 5,302,454 teaches a composition comprising first, 10-60 weight percent of a homopolymer polypropylene having an isotactic index greater than 90 or of a crystalline propylene copolymer with ethylene with CH₂═CHR olefin where R is a 2-6 carbon alkyl radical, or combinations thereof, containing more than 85 weight percent of propylene and having an isotactic index greater than 85; second, 10-40 weight percent of a crystalline polymer fraction containing ethylene and propylene, having an ethylene content of from 52.4 percent to about 74.6 percent and which is insoluble in xylene at room temperature; and third, 30-60 weight percent of an amorphous ethylene-propylene copolymer containing optionally small proportions of a diene, soluble in xylene at room temperature and contains 40-70 weight percent of ethylene; where the composition has a flex modulus smaller than 700 MPa, tension set at 75 percent, less than 60 percent, tensile stress greater than 6 MPa.

U.S. Pat. No. 5,368,927 teaches a composition comprising first, 10-60 weight percent of a homopolymer polypropylene having an isotactic index greater than 80 or of a crystalline propylene copolymer with ethylene and/or an alpha-olefin having 4-10 carbon atoms, containing more than 85 weight percent of propylene and having an isotactic index greater than 80; second, 3-25 weight percent of an ethylene-propylene copolymer insoluble in xylene at room temperature; and third, 15-87 weight percent of a copolymer of ethylene with propylene and/or an alpha-olefin having 4-10 carbon atoms, and optionally a diene, containing 20-60 percent of ethylene, and completely soluble in xylene at ambient temperature.

Suitable heterophasic polymers are produced by the catalloy process and available commercially under the trade designation “ADFLEX” from Basell Polyolefins of Wilmington, Del., and polypropylene. Specific commercial examples are ADFLEX® KS-084P, ADFLEX®) KS-057P and KS-357P, which has a melt flow rate of 25.

The layer(s) of the paper of this invention may also contain fillers such as calcium carbonate (CaCO3), various clays, silica (SiO2), alumina, barium sulfate, sodium carbonate, talc, magnesium sulfate, zeolites, aluminum sulfate, cellulose-type powders, diatomaceous earth, gypsum, magnesium sulfate, magnesium carbon-ate, barium carbonate, leaolin, mica, carbon, calcium oxide, magnesium oxide, zinc oxide, aluminum hydroxide, pulp powder, wood powder, cellulose derivatives, polymeric particles, chitin and chitin derivatives. These additives are desirably coated to improve their UV stability and improve their flow properties with, for example, behenic acid, stearic acid and fatty acids having between about 10 and 50 carbon atoms. The fillers of this invention are not believed to impart breathability to the paper, since the papers of this invention are substantially thicker than, for example, a film. Breathability is not an important attribute for synthetic papers for outside use.

Calcium carbonate is known in the art of film making as a relatively standard filler and a suitable source is Imerys (Roswell, Ga.) FL-2029, having an average particle size of 1 micron. Calcium carbonate may be added to the layers at an amount of about 15 to 50 weight percent, more desirably from about 20 to 30 weight percent.

The synthetic paper of this invention must also have an additive to help protect the paper from the effects of sunlight. This material is known as an ultraviolet (UV) stabilizer and may be added to the polymer prior to or during the melting of the polymer to produce the film. As such, it is an internal additive, as differentiated from a topically applied additive.

The UV stabilizer may be any of those known as hindered amines. Hindered amines are discussed in U.S. Pat. No. 5,200,443 to Hudson and examples of such amines are HOSTAVIN® TMN 20 from American Hoescht Corporation of Somerville, N.J., CYASORB® UV-3668 from American Cyanamid Company of Wayne, N.J., UVASIL®-299 from Enichem Americas, Inc. of New York, CHIMASSORB® from the Ciba Specialty Chemicals and TINUVIN®, also from Ciba Specialty Chemicals. TINUVIN® 783 is a 1:1 blend of CHIMASSORB® 944 and TINUVIN® 622. TINUVIN® 622 is dimethyl succinate polymer with 4-hydroxy-2,2,6,6, tetramethyl-1-piperidineethanol. CHIMASSORB® 944 is poly[[6-[(1,1,3,3, tetramethyl butyl)amino]-s-triazine-2,4-diyl][[(2,2,6,6,-tetramethyl-4-piperidyl) imino]hexamethylene [(2,2,6,6-tetrametyl-4-piperidyl) imino]]. Numerous grades of CHIMASSORB® and TINUVIN®) are available and may be used depending on the properties desired by the developer.

In contrast with previous work in which the hindered amine was an incidental additive, the hindered amine light stabilizing material may be present in this invention at an amount of about 0.25 to 10 weight percent, more particularly between about 0.25 and 5 weight percent. Still more particularly, the hindered amine may be present in an amount of about 0.25 to 1 weight percent or even more desirably about 1.25 weight percent in the skin and about 0.5 weight percent in the core.

Titanium dioxide (TiO₂) is available from E. I. duPont de Nemours & Co. of Wilmington, Del., under the trade name TI-PURE®. A number of grades of TiO2 are available under the TI-PURE® mark. Suitable examples are duPont's TI-PURE®) R-960, and R-105 rutile TiO₂. These grades are coated with silica to increase their UV resistance. Titanium dioxide may be added to the layers at an amount of about 0.25 to 10 weight percent or more desirably from about 2 to 7 weight percent.

Other additives include hindered phenols which are used as a melt flow stabilizer that prevents thermal degradation during polymer melt processing. Vitamin E is a suitable hindered phenol and is discussed in U.S. Pat. No. 6,156,421. Vitamin E is available as IRGANOX® E 201 from Ciba Specialty Chemicals of Tarrytown, N.Y. Other hindered phenols are also available, such as IRGANOX®) E 217 from Ciba Specialty Chemicals, among others.

Another suitable stabilizer from Ciba Specialty Chemicals is IRGANOX®) B 921, a 1:2 mixture of IRGANOX® 1076 hindered phenol and IRGAFOS® 168 phosphite stabilizer. It's believed that the phosphite reduces heat aging of polymers to retain physical properties.

The hindered phenol and phosphite may collectively be added to the layers at very low amounts; about 0.1 to 1 weight percent, more particularly, about 0.25 weight percent. The paper of this invention, though superficially similar to those disclosed in, for example, U.S. Pat. No. 6,156,421, was found to be surprisingly resistant to ultraviolet radiation, as will be shown below.

The paper of this invention may be made by any suitable method known to those skilled in the art. These include the cast or blown film methods followed by biaxial stretching in amounts of about 5 to 8 times in both directions. The films are generally formed at about 40-75 mils thickness and stretched to a final thickness of 1.5 to 12 mils, desirably between about 2 and 10 mils, more desirably between about 4 and 6 mils. It should be noted that “papers” are generally thicker than films. Films of, for example, U.S. Pat. No. 6,156,421, are substantially, e.g., 6 to 7 or more times, thinner than the paper of the instant invention. The thickness of the paper results in a stiffer, more mechanically durable material without breathability.

Suitable methods of making films are also described in U.S. Pat. Nos. 6,083,443 and 6,156,421. One process for producing a polyolefin film is concluded by orientating the primary film in a manner known per se, either biaxially in longitudinal and trans-verse directions in sequence one after the other or simultaneously in both directions at the same time, and obtaining the finished biaxially oriented polyolefin film having one or more layers after cooling and normally winding it up to produce a roll. In another process, the film may be stretched, in at least one direction, as is known in the art such as, for example, using a machine direction orientor (MDO). MDO units are commercially available from the Marshall and Williams Company of Providence, R.I. and others. An MDO unit has a plurality of stretching rollers, which progressively stretch and thin the film in the machine direction. Further, the film may be stretched in a single continuous zone or stretched in multiple distinct zones

The above mentioned characteristics of the paper of this invention are illustrated by the examples below, results of the testing of which are given in Table 1. It should be noted that only Examples 1, 2 and 3 are examples of this invention.

### EXAMPLE 1

A synthetic paper was produced as a cast film and biaxially stretched on a tenter frame. The paper had three layers, a core or “B” layer and two skin or “A” layers. The B layer had about 86 weight percent of the laminate and each A layer contributed about 7 weight percent of the laminate. The thickness of this paper was 2.1 mils.

Core: The B layer was made from about 82 weight percent of Exxon/Mobil's PLTD 3854 metallocene polypropylene (24 MFR), about 27 weight percent Imerys' FL-2029 calcium carbonate, about 2.5 weight percent duPont's TI-PURE® R 960 TiO₂, about 0.5 weight percent TINUVIN® 783 hindered amine, about 0.06 weight percent of IRGANOX® 168 phosphite additive, about 0.13 weight percent IRGANOX® E 217 hindered phenol additive and about 0.06 weight percent of calcium oxide.

Skin: The A layers were made from about 64 weight percent of Exxon/Mobil's 3854 metallocene polypropylene, about 27 weight percent Imerys' FL-2029 calcium carbonate, about 7.5 weight percent duPont's TI-PURE®) R 960 TiO₂, about 1.25 weight percent TINUVIN® 783 hindered amine, about 0.06 weight percent of IRGANOX® B921 additive, about 0.13 weight percent IRGANOX® E 217 additive and about 0.06 weight percent of calcium oxide.

### EXAMPLE 2

A synthetic paper was produced as a cast film and biaxially stretched on a tenter frame. The paper had three layers, a core or “B” layer and two skin or “A” layers. The B layer had about 90 weight percent of the laminate and each A layer contributed about 5 weight percent of the laminate. The thickness of this paper was 3.0 mils.

Core: The B layer was made from about 71 weight percent of Exxon/Mobil's PLTD 1542 polypropylene, about 25 weight percent Imerys' FL-2029 calcium carbonate, about 3.25 weight percent duPont's TI-PURE® R 960 TiO₂, about 0.5 weight percent TINUVIN® 783 hindered amine, about 0.2 weight percent of IRGANOX® B921 additive and about 0.05 weight percent of calcium oxide.

Skin: The A layers were made from about 43.5 weight percent of Exxon/Mobil's ACHIEVE® 1654 polypropylene, about 10 weight percent ADFLEX® KS 357P polypropylene (25 MFR), about 40 weight percent Imerys' FL-2029 calcium carbonate, about 5 weight percent duPont's TI-PURE® R 960 TiO₂, about 1.25 weight percent TINUVIN® 783 hindered amine, about 0.2 weight percent of IRGANOX® B921 additive and about 0.05 weight percent of calcium oxide.

### EXAMPLE 3

A synthetic paper was produced as a cast film and biaxially stretched on a tenter frame. The paper had three layers, a core or “B” layer and two skin or “A” layers. The B layer had about 90 weight percent of the laminate and each A layer contributed about 5 weight percent of the laminate. The thickness of this paper was 3.2 mils.

Core: The B layer was the same as in Example 1.

Skin: The A layers were made from about 64 weight percent of Exxon/Mobil's PLTD 1542 metallocene polypropylene, about 27 weight percent FL-2029 calcium carbonate, about 7.5 weight percent duPont's R960 TiO₂, about 1.25 weight percent TINUVIN® 783 hindered amine, about 0.2 weight percent of IRGANOX® B921 additive and about 0.05 weight percent of hydrated lime.

### EXAMPLE 4

A synthetic paper available from UCB Films, Inc., of Smyrna, Ga. under the name RAYOART® TC-23-360. This is a co-extruded polypropylene film.

### EXAMPLE 5

A synthetic paper available from Avery Dennison of Painesville, Ohio under the name FASSON COPY CODE®. This is a copolymer of ethylene, propylene and vinyl acetate.

### EXAMPLE 6

A synthetic paper available from Rocheux International, Inc. of Batavia, Ill. under the name Nan Ya PT-72 film. This is a polypropylene film.

### Test Method

In order to determine how well the papers of the Examples held up to UV exposure, the papers of Examples 1 through 6 were tested in an Atlas Ci 135 WEATHER-O-METER® tester according to ASTM G155-98 method. This is an accelerated weathering test designed to mimic the effects of actual exposure to the elements. It's believed by the inventors that 1000 hours of such testing is equivalent to at least 9 months and perhaps as long as a year, of actual outdoor exposure.

In the test, the samples are subjected to a continuous light with 30 minutes of water spray out of every 90 minutes. The light was a xenon arc lamp with borosilicate inner and outer filters with an irradiance of 0.35 watts/m² at 340 nanometers wave length. The relative humidity was 65 percent and the black panel temperature was 70° C. The results are given in Table 1.

TABLE 1
UV Stability/Outdoor Weatherability Testing
% Retention of Tensile Strength

| | Exposure Time Hours | | | | |
|---|---|---|---|---|---|
| | 0 | 337.5 | 675 | 1012.5 | 1350 |
| Example 1 | 100 | 100 | 99 | 96 | 83 |
| Example 2 | 100 | 100 | 96 | 99 | 87 |
| Example 3 | 100 | 79 | 84 | 76 | 83 |
| Example 4 | 100 | 0 | 0 | 0 | 0 |
| Example 5 | 100 | 12 | 0 | 0 | 0 |
| Example 6 | 100 | 25 | 5 | 0 | 0 |

% Retention of Stretch

| | Exposure Time Hours | | | | |
|---|---|---|---|---|---|
| | 0 | 337.5 | 675 | 1012.5 | 1350 |
| Example 1 | 100 | 100 | 100 | 83 | 82 |
| Example 2 | 100 | 95 | 87 | 78 | 62 |
| Example 3 | 100 | 91 | 89 | 88 | 85 |
| Example 4 | 100 | 0 | 0 | 0 | 0 |
| Example 5 | 100 | 1 | 0 | 0 | 0 |
| Example 6 | 100 | 2 | 1 | 0 | 0 |

It is clear from the above results that the samples in accordance with the invention lost far less of their stretch and tensile properties on exposure to UV light. The paper of this invention maintained at least 75 percent of each of its tensile strength and stretch properties after 1000 hours of accelerated weatherability testing.

While three layer laminates have been the focus thus far, this invention is not limited to three layers. It is possible to add further layers to the invention or to produce the desired UV resistance in a single or two layer embodiment.

A single layer paper could have, for example, between about 45 and 80 weight percent, desirably between about 55 and 70 weight percent of a polyolefin. The polyolefin may be polypropylene and the polypropylene may be made by the metallocene process. The polypropylene may also include heterophasic polypropylene. The single layer should have calcium carbonate in an amount of about 15 to 50 weight percent or more particularly between about 20 and 40 weight percent, titanium dioxide in an amount of about between about 0.25 and 10 weight percent, more particularly between about 2 and 7 weight percent, and a hindered amine light stabilizing material may be added to the layers at an amount of about 0.25 to 10 weight percent, more particularly between about 0.25 and 5 weight percent. Hindered phenol and phosphite may collectively be added to the layer at an amount of about 0.1 to 1 weight percent, more particularly, about 0.25 weight percent. Further examples of single layer embodiments include:

### EXAMPLE 7

A single layer about 3 mils thick made from 58.5 weight percent Exxon/Mobil PLTD 1594 mPP polypropylene (11.5 MFR), 35 weight percent Imerys' FL-2029 calcium carbonate (1 micron average particle size), 5 weight percent duPont's TI-PURE® R 960 TiO₂, 1.25 weight percent TINUVIN®) 783 hindered amine, 0.2 weight percent IRGANOX® B921 additive and 0.05 weight percent calcium oxide.

### EXAMPLE 8

A single layer about 3 mils thick, made from 58.5 weight percent Exxon/Mobil PLTD 1594 mPP polypropylene (11.5 MFR), 35 weight percent OMYACARB® 2 SS T-FL calcium carbonate (2 micron average particle size) from Omya Chemical of Vermont, 5 weight percent duPont's TI-PURE® R 960 TiO₂, 1.25 weight percent TINUVIN® 783 hindered amine, 0.2 weight percent IRGANOX® B921 and 0.05 weight percent calcium oxide.

### EXAMPLE 9

A single layer about 3 mils thick, made from 66.65 weight percent Exxon/Mobil PLTD 1594 mPP polypropylene (11.5 MFR), 25 weight percent OMYACARB® 2 SS T-FL calcium carbonate (2 micron average particle size), 5 weight percent duPont's TI-PURE® R 960 TiO₂, 1.25 weight percent TINUVIN® 783 hindered amine, 2 weight percent of PLTD 1594 containing 5 weight percent vitamin E, 0.05 weight percent IRGAFOS® 168 and 0.05 weight percent calcium oxide.

A two layer embodiment could have, for example, two skin layers as described for the three layer embodiment, without the core layer. Alternatively, dual core layers could be produced, deleting any skin layers. A two layer embodiment similar to the Examples 1-3 with only one skin layer would also be useful in applications in which one side of the paper was not exposed to UV light, such as labeling of products for outdoor use or storage where one side of the label was affixed to the item.

As mentioned above, additional layers may be added to the paper of this invention.

These layers may be placed on top of either or both skin layers or inserted between about a skin layer and the core.

As will be appreciated by those skilled in the art, other changes and variations to the invention are considered to be within the ability of those skilled in the art. Examples of such changes are contained in the patents identified above, each of which is incorporated herein by reference in its entirety to the extent it is consistent with this specification. Such changes and variations are intended by the inventors to be within the scope of the invention.

What is claimed is:

1) A synthetic paper comprising three layers; a core layer and, on either side of said core layer, a skin layer, wherein;
the core layer is made from about 50 to about 90 weight percent polypropylene, about 15 to 50 weight percent calcium carbonate, about 0.25 to 10 weight percent TiO₂, about 0.25 to 10 weight percent hindered amine, and about 0.1 to 10 weight percent of a phosphite and a hindered phenol, collectively, and,
the skin layer is made from about 35 to 85 weight percent of polypropylene, about 15 to 50 weight percent calcium carbonate, about 0.25 to 10 weight percent TiO₂, about 0.25 to 10 weight percent hindered amine, and about 0.1 to 0.5 weight percent of a phosphite and a hindered phenol, collectively.

2) The paper of claim 1 wherein said outer layer polyolefin is a polypropylene.

3) The paper of claim 1 wherein said inner layer polyolefin is a polypropylene.

4) The paper of claim 1 wherein said first and second layers further comprise a heterophasic polymer.

5) The paper of claim 4 wherein said polymer is polypropylene.

6) The paper of claim 1 wherein said hindered amine is present in an amount of about from 0.25 to about 5 weight percent.

7) The paper of claim 1 wherein at least one of said layers has pigment present in an amount less than 5 weight percent.

8) The paper of claim 1 which maintains 75 percent of its tensile and stretch properties after exposure to 1000 hours of weatherability testing.

9) A synthetic paper comprising three layers;
a core layer contributing about 90 weight percent of said paper and, on either side of said core layer, a skin layer, each skin layer contributing about 5 weight percent of said paper, wherein;
the core layer is made from about 65 to about 85 weight percent polypropylene, about 20 to 30 weight percent calcium carbonate, about 2 to 7 weight percent TiO₂, about 0.25 to 1 weight percent hindered amine, and about 0.1 to 0.5 weight percent of a phosphite and a hindered phenol, collectively, and,
the skin layer is made from about 40 to 70 weight percent of polypropylene, about 20 to 30 weight percent calcium carbonate, about 2 to 7 weight percent TiO₂, about 0.25 to 1 weight percent hindered amine, and about 0.1 to 0.5 weight percent of a phosphite and a hindered phenol, collectively.

10) The synthetic paper of claim 9 wherein said skin layer includes a heterophasic polypropylene in an amount between about 5 and 20 weight percent.

11) The synthetic paper of claim 9 wherein said polypropylene is a metallocene polypropylene.

12) A synthetic paper comprising one layer, said layer made from between about 45 and 80 weight percent of a polyolefin, calcium carbonate in an amount of about between about 15 and 50 weight percent, titanium dioxide in an amount between about 0.25 and 10 weight percent and a hindered amine light stabilizing material present at an amount of about between about 0.25 and 10 weight percent.

13) The synthetic paper of claim 12 wherein said polypropylene is produced by a metallocene process.

14) The synthetic paper of claim 12 further comprising a heterophasic polypropylene.

15) The synthetic paper of claim 12 further comprising about 0.1 to 1 weight percent of a phosphite and a hindered phenol, collectively.

16) The synthetic paper of claim 15 wherein said polypropylene is present in an amount between about 55 and 70 weight percent, said calcium carbonate is present in an amount between about 20 and 40 weight percent, said titanium dioxide is present in an amount between about 2 and 7 weight percent and said hindered amine is present in an amount between about 0.25 and 5 weight percent.
